(19) United States
(12) Patent Application Publication
(10) Pub. No.: US 2008/0075920 A1
(43) Pub. Date: Mar. 27, 2008

(54) ALUMINUM ALLOY HOUSING STRUCTURE AND METHOD MAKING THE SAME

(76) Inventors: Yung-Hung Chih, Shuh-Lin City (TW); Szu-Song Chen, Keelung City (TW); Shin-Di Lee, Dong-Shi Township (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/534,012

(22) Filed: Sep. 21, 2006

(51) Int. Cl. G11B 5/64

(52) U.S. Cl. 428/141

(57) ABSTRACT

An aluminum alloy housing structure and method making the same. By placing said aluminum alloy housing to be processed in a processing device, processing the skin of said aluminum alloy housing in a mechanical procession manner without involving any chemical solution to form on the skin of said aluminum alloy housing a recess region having a plurality of fine holes, and binding directly a highly flowing plastic material in said recess region by injection-molding, in combination with a mold, said plastic material into said recess region, thereby an environment-friend aluminum alloy/plastic composite with good binding ability can be form on said aluminum alloy housing.

### BACKGROUND OF THE INVENTION

1. Field of the invention

The invention relates to an aluminum alloy housing structure and a method making the same, and in particular, to a structure and a method for making the same, by processing on the skin of an aluminum alloy in a mechanical processing manner to yield a recess region having a plurality of fine holes therein, following by injection-molding plastic material in these holes to form a composite of the aluminum alloy and the plastic.

2. Description of the prior art

Aluminum alloys exhibits several advantageous characteristics, such as, for example, lightweight, less tendency to rust, easy procession, ready to install, and the like, and therefore, has been employed extensively as the material for manufacturing housing of 3C products, especially notebook housing and cell phone casing. Since a housing is the straightest way for protecting these products, a usual approach is to combine a plastic material with good heat resistance, stability and processing flowability over the aluminum alloy housing to enhance its hardness in order to keep its excellent performance. In the past, methods for enhancing the hardness of an aluminum alloy sheet with a plastic material began largely with a step of etching chemically over the skin of the aluminum alloy to yield crimpy, scraggy recess lines in the skin of the aluminum alloy, and then filling a plastic material into these line over the aluminum alloy sheet. However, there was a fetal disadvantage associated with chemical etching in that, in its operation, large amount of strong acidic and strong alkaline etching waste liquor might be produced, as well as a large amount of time should be taken for washing the processed sheet which might yield unrecoverable clearing waste liquid. Therefore, though the conventional etching technique could meet the requirement for processing an aluminum alloy sheet, in practice, it is complicated and time-consuming, and may produce highly hazardous and non-reusable chemical waste liquid after etching, which will form a secret worry on workers and the environment, as well as become an enormous burden on the dealer. Furthermore, as the environmental protection concept is daily increased, the disposal of those etching waste liquid has become an issue to be solved as soon as possible.

Accordingly, in view of those disadvantages associated with the conventional procession process on the aluminum alloy sheet and for improving these disadvantages, the inventor had studied intensively and developed finally an aluminum alloy structure and a method making the same characterized in that it skips over the conventional step for clearing and drying the etched alloy sheet, and coats a plastic film directly over the machine processed aluminum alloy sheet, so as to achieve the requirement of a beltline, time- and labor-saving, and environmental protection as well as can overcome those disadvantages of prior art.

### SUMMARY OF THE INVENTION

The main object of the invention is to provide an aluminum alloy housing structure and a method for making the same, by processing on the skin of an aluminum alloy in a mechanical processing manner to yield a recess region having a plurality of fine holes distributed over its surface, following by injection-molding plastic material into these holes to form a composite of the aluminum alloy and the plastic.

Another object of the invention is to provide an aluminum alloy housing structure and a method for making the same, characterized in that it takes advantage of mechanical procession in stead of conventional chemical etching solution, such that the large amount of time consumed in washing etched sheet can be saved, which can promote the procession efficiency on the aluminum alloy sheet and reduce the environmental pollution generated during the procession.

For better understanding of the invention, the subject matter and effects thereof according to the invention will be described in detail hereinafter by way of the following preferred embodiments in conjunction with the accompanying drawings and figures.

### BRIEF DESCRIPTION OF THE DRAWINGS

FIG. 1 is a schematic view showing the process for reinforcing the skin of an aluminum alloy sheet.

FIG. 2 is a schematic enlarged view of a portion of an aluminum alloy housing structure.

### DETAILED DESCRIPTION OF THE PREFERRED EMBODIMENT

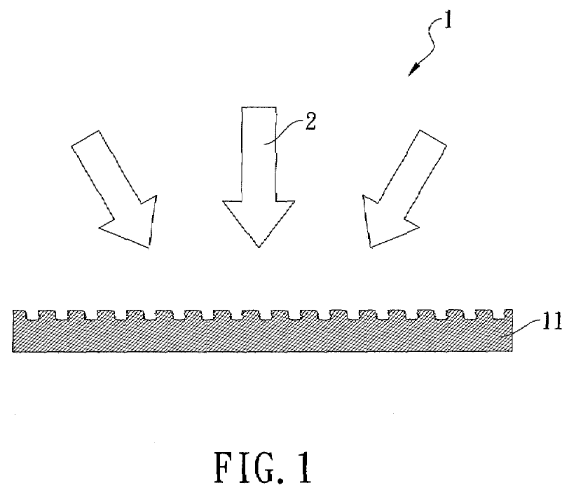

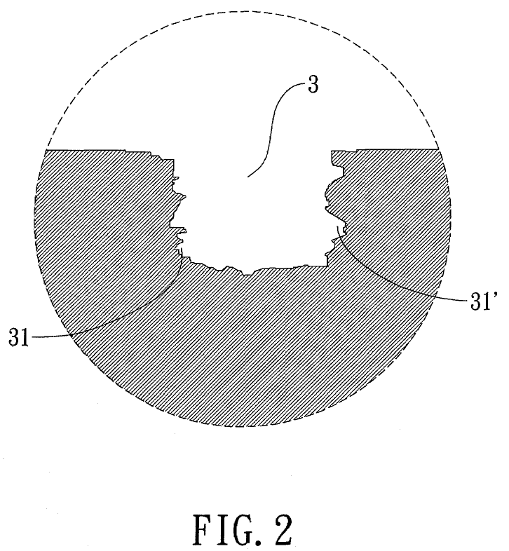

Referring to FIG. 1 and 2, in these cross-section views, the aluminum alloy housing structure according to the invention comprises an aluminum alloy sheet 1 and a composite plastic layer (not shown), wherein said aluminum alloy sheet 1 has been processed physically by means of mechanical procession 2, such as, for example, micro-mechanical procession or by means of a laser beam from a computer-controlled high energy laser device, in contact or non-contact manner, so as to provide over the skin 11 of said sheet with a recess region 3 having a given depth and also a plurality of fine holes (31, 31′) with varying depth distributed over its surface such that the surface contact area in said recess region 3 can be increased to a large extent.

Then, the processed aluminum alloy sheet 1 is transferred into a matched mold (not shown in the figure) and a highly flowing plastic material, such as, for example, polybutylene terephthalate (PBT) or a blend of PBT and polycarbonate (PC), is injection-molded directly into said recess region 3 to form an aluminum-plastic composite.

Based on the above-disclosed description and drawings, objects of the invention can be achieved by providing a method for making the aluminum alloy housing structure, wherein the skin of a aluminum alloy sheet to be processed is mechanically worked, such as, for example, by micro-mechanical processing or using a computer-controlled laser device, over the originally planar skin 11 of said sheet to form a recess region having a plurality of fine holes; and then, by injection-molding a plastic material (PBT or PBT+PC) in combination with a mold into said recess region such that said plastic material can be bound within said recess region. After said plastic is cooled and solidified, the sheet thus processed is removed from the mold, whereby an aluminum alloy/plastic composite composed of an aluminum alloy and a plastic material is formed over the surface of said sheet.

From the forgoing, it is apparent that the aluminum alloy housing structure according to the invention exhibits following advantages:
1. In view of the vigorously developing in the mold and 3C industries, to have a high speed, high production efficiency production process is the tendency for the future development. In the method of the invention, immediately after the procession of the aluminum alloy sheet, the sheet is transferred in a matching mold and a plastic material injection-molding is carried out over said sheet, thereby it reduces the conventional multi-step procession process into a beltline production process with only two steps, which increases largely the production speed and lowers cost, and hence an enormous economic profit can be obtained.
2. With the computer-controlled mechanical procession process, such as micro-mechanical procession or laser procession, an aluminum alloy sheet with complex shape can be treated quickly and precisely, which leads the method for making an aluminum alloy housing structure according to the invention to become a high speed, low cost, good quality composite molding technique with high competitiveness and developing potential.
3. The method for making an aluminum alloy housing structure according to the invention takes advantage of physical mechanical processing process instead of conventional chemical etching technology, thereby skips the generation of large amount of hazardous chemical waste liquid, which not only minimizes the potential harmful risk to the worker, but also accomplishes the purpose of environmental protection.

While the invention has been described above in terms of its embodiment and technical means, various changes and modifications can be made readily based on the disclosure or teaching herein without departing form the spirit and the scope set forth in the specification, drawings or the appended claims, and those changes and modifications are intended to be encompassed within the technical scope of the invention.

What is claimed is:

1. An aluminum alloy housing structure, comprising:
an aluminum alloy sheet, with its skin mechanically processed to form a recess region therein having a plurality of fine holes distributed over the surface of said recess region; and
a composite plastic layer, bound in said recess region.

2. The aluminum alloy housing structure as claimed in claim 1, wherein said mechanical procession is a micro-mechanical procession, which is carried out in a contact manner over said skin of said aluminum alloy sheet to form a recess region with a plurality of fine holes therein.

3. The aluminum alloy housing structure as claimed in claim 1, wherein said skin of said aluminum alloy sheet is provided obliquely with a recess region having a plurality of fine holes therein.

4. The aluminum alloy housing structure as claimed in claim 1, wherein said composite plastic layer is bound within said recess region of said aluminum alloy sheet by injection-molding with a highly flowing plastic material.

5. The aluminum alloy housing structure as claimed in claim 4, wherein said highly flowing plastic material is polybutylene terephthalate (PBT) or a blend of PBT and polycarbonate (PC).

6. A method for making an aluminum alloy housing structure, comprising following steps:
(1) mechanical processing the skin of an aluminum alloy sheet to form, over the surface of the sheet, a recess region having a plurality of fine holes therein; and
(2) binding directly a plastic material in said recess region by injection-molding, in combination with a mold, said plastic material into said recess region.

7. The method for making an aluminum alloy housing structure as claimed in claim 6, wherein said mechanical procession in step (1) is carried out by employing a computer-controlled laser device over the skin of said aluminum alloy sheet.

8. The method for making an aluminum alloy housing structure as claimed in claim 6, wherein said mechanical procession in step (1) is a micro-mechanical procession, which is carried out in a contact manner over said skin of said aluminum alloy sheet to form a recess region having a plurality of fine holes therein.

9. The method for making an aluminum alloy housing structure as claimed in claim 6, wherein said mechanical procession in step (1) comprises of providing obliquely on said skin of said aluminum alloy sheet with a recess region having a plurality of fine holes therein.

10. The method for making an aluminum alloy housing structure as claimed in claim 6, wherein, in said step (2), said plastic material comprises a highly flowing plastic material of polybutylene terephthalate (PBT) or a blend of PBT and polycarbonate (PC).
